(19) United States
(12) Patent Application Publication
(10) Pub. No.: US 2025/0183377 A1
(43) Pub. Date: Jun. 5, 2025

(54) METAL AQUEOUS BATTERY INCLUDING AN ANODE CURRENT COLLECTOR

(71) Applicants: HYUNDAI MOTOR COMPANY, Seoul (KR); KIA CORPORATION, Seoul (KR)

(72) Inventors: Yun Su Lee, Yongin-si (KR); Se Won Pyo, Uiwang-si (KR); Shin Tae Bae, Incheon (KR); Ji Hoon Jang, Suwon-si (KR)

(73) Assignees: HYUNDAI MOTOR COMPANY, Seoul (KR); KIA CORPORATION, Seoul (KR)

(21) Appl. No.: 18/653,332

(22) Filed: May 2, 2024

(30) Foreign Application Priority Data
Dec. 4, 2023 (KR) 10-2023-0172985

(51) Int. Cl. H01M 10/28; H01M 4/02; H01M 4/38; H01M 4/76; H01M 10/26; H01M 50/474; H01M 50/477

(52) U.S. Cl. CPC H01M 10/288; H01M 4/38; H01M 4/762; H01M 10/26; H01M 50/474; H01M 50/477; H01M 2004/021; H01M 2300/0014

(57) ABSTRACT

A metal aqueous battery includes a double cell comprising a pair of single cells. In particular, each single cell includes: an anode; a cathode; a separator interposed between the anode and the cathode; a plate having an internal space configured to accommodate the anode; and an anode current collector seated in the internal space. The internal space of the plate communicates with an outside via an opening formed in one surface of the plate. In addition, the anode current collector comprises a body having a shape of a container having an open upper part and a closed bottom surface so as to accommodate the anode. The metal aqueous battery has a new structure in which a current generation rate is increased.

### CROSS-REFERENCE TO RELATED APPLICATION

This application claims under 35 U.S.C. § 119 (a) the benefit of and the priority to Korean Patent Application No. 10-2023-0172985 filed on Dec. 4, 2023, the entire contents of which are incorporated herein by reference.

### TECHNICAL FIELD

The present disclosure relates to a metal aqueous battery including an anode current collector with a new structure in which a current generation rate is increased.

### BACKGROUND

Recently, research on electrochemical water electrolysis is actively underway in line with development of renewable energy to respond to climate change. Further, importance of carbon dioxide (CO₂) capture, storage, and conversion technologies to reduce greenhouse gases is increasing.

A zinc/aluminum (Zn/AI)—based aqueous battery system is a very economical metal cathode candidate in terms of price and reserves. The zinc/aluminum (Zn/AI)-based aqueous battery system is a system that produces hydrogen and simultaneously captures carbon dioxide in the form of salts, such as KHCO₃.

However, existing metal aqueous batteries are a single cell including one anode and one cathode or a stack of these single cells, and therefore current obtained from the existing metal aqueous batteries is limited.

The above information disclosed in this Background section is only for enhancement of understanding of the background of the present disclosure, and therefore the Background section may contain information that does not form the prior art that is already known to a person of ordinary skill in the art.

### SUMMARY

The present disclosure has been made in an effort to solve the above-described problems associated with the prior art, and it is an object of the present disclosure to provide a metal aqueous battery having improved current generation amount and current generation rate.

It is another object of the present disclosure to provide a metal aqueous battery in which an electrolyte may circulate smoothly.

The objects of the present disclosure are not limited to the above-mentioned objects. The objects of the present disclosure should become clearer from the following description and may be realized by means stated in the claims and combinations thereof.

In one aspect of the present disclosure, a metal aqueous battery includes a double cell formed by stacking a pair of single cells. Each single cell includes an anode, a cathode, and a separator disposed between the anode and the cathode. A cathode current collector is interposed between the respective cathodes of the single cells so that the cathodes face each other. Each single cell may include a plate including an internal space configured to accommodate the anode. The internal space of the plate communicates with an outside as one surface of the plate is open toward the separator. Each single cell may include an anode current collector seated in the internal space. The anode current collector may include a body having a shape of a container having an open upper part and a closed bottom surface so as to accommodate the anode.

In an embodiment, the plate may be provided in a form of a barrel including a lower surface, a front surface configured to be at least partially open, a rear surface configured to face the front surface, and side surfaces configured to connect the front surface and the rear surface. The plate may include a first anode electrolyte inlet formed in one area of the lower surface, a second anode electrolyte inlet formed in some areas of the rear surface, and anode electrolyte outlets formed in upper parts of the side surfaces.

In another embodiment, the anode current collector may further include an extension having a shape of a panel configured to extend upwards from the body. The extension may be exposed to an outside of the plate and may be connected to the cathode current collector by a conductive wire.

In another embodiment, the body may be in a form of a square barrel having the open upper part.

In another embodiment, the body may include a first plate portion provided close to the separator and may include a second plate portion configured to face the first plate portion. At least one of the first plate portion or the second plate portion of the body may have an inclined shape from top to bottom.

In another embodiment, the body may include a plurality of through holes formed therethrough and having a predetermined shape, and an anode electrolyte may pass through the body via the through holes.

In another embodiment, the anode current collector may further include at least one auxiliary plate inserted into the body. The auxiliary plate may include a plurality of through holes formed therethrough and having a predetermined shape.

In another embodiment, the anode may have a form of pellets.

In another embodiment, an average diameter of the anode may be 1 mm to 10 mm.

In another embodiment, the anode may include at least one selected from the group consisting of lithium (Li), sodium (Na), magnesium (Mg), zinc (Zn), aluminum (Al), and combinations thereof.

In another embodiment, the cathode may include a noble metal catalyst supported on a carrier.

In another embodiment, each single cell may further include a cathode spacer interposed between the separator and the cathode to form a gap between the separator and the cathode.

In another embodiment, the cathode spacer may be provided in a form of a frame with a hole in a central portion thereof and may support an edge of the separator to form the gap. The cathode spacer may include a cathode electrolyte inlet formed through a portion of one side surface of the cathode spacer so as to communicate with the gap. The cathode spacer may also include a cathode electrolyte outlet formed through a portion of another side surface of the cathode spacer at a position spaced apart from the cathode electrolyte inlet by a designated distance so as to communicate with the gap.

In another embodiment, the metal aqueous battery may further include a separator spacer interposed between the plate and the separator. The separator spacer has a designated thickness and is provided in a form of a frame with a hole in a central portion thereof. The separator spacer may support an edge of the separator to expand the internal space of the plate by a thickness of the separator spacer.

In another embodiment, the metal aqueous battery may further include an anode electrolyte accommodated in a space between the anode and the separator. The metal aqueous battery may further include a cathode electrolyte accommodated in a space between the cathode and the separator.

In another embodiment, the anode electrolyte may include an alkali metal hydroxide.

In another embodiment, the cathode electrolyte may include hydrogen ions and bicarbonate ions.

Other aspects and embodiments of the present disclosure are discussed infra. The above and other features of the present disclosure are discussed infra.

### BRIEF DESCRIPTION OF THE DRAWINGS

The above and other features of the present disclosure are now described in detail with reference to certain embodiments thereof illustrated in the accompanying drawings, which are given for the purpose of illustration only and thus do not limit the present disclosure, and wherein:

FIG. 1 shows a metal aqueous battery according to an embodiment of the present disclosure;

FIG. 2 shows a plate according to an embodiment of the present disclosure;

FIG. 3 shows an anode current collector according to a first embodiment of the present disclosure;

FIG. 4 shows an anode current collector according to a modified example of the present disclosure;

FIG. 5 shows an anode current collector according to a second embodiment of the present disclosure;

FIG. 6 shows an anode current collector according to a third embodiment of the present disclosure;

FIG. 7 shows an anode current collector according to a fourth embodiment of the present disclosure;

FIG. 8 shows flows of electrolytes in the metal aqueous battery according to the present disclosure;

FIG. 9 shows a cathode spacer according to the present disclosure;

FIG. 10 shows a metal aqueous battery according to Comparative Example;

FIG. 11 shows cell performances of metal aqueous batteries according to Example 1 and Comparative Example; and

FIG. 12 shows cell performances of metal aqueous batteries according to Examples 2 to 4.

It should be understood that the appended drawings are not necessarily to scale. The appended drawings present a somewhat simplified representation of various features and illustrate the basic principles of the present disclosure. The specific design features of the present disclosure as disclosed herein, including, for example, specific dimensions, orientations, locations, and shapes, should be determined in part by the particular intended application and use environment.

In the figures, same reference numbers refer to the same or equivalent parts of the present disclosure throughout the drawings.

### DETAILED DESCRIPTION

The above-described objects, other objects, advantages, and features of the present disclosure should become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those having ordinary skill in the art.

In the drawings, the same or similar elements are denoted by the same reference numerals even though the elements are depicted in different drawings. In the accompanying drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly a second element may be named a first element, without departing from the scope and spirit of the present disclosure. Singular expressions may encompass plural expressions, unless the expressions have clearly different contextual meanings.

In the following description of the embodiments, terms, such as “including”, “comprising” and “having”, should be interpreted as indicating the presence of characteristics, numbers, steps, operations, elements or parts stated in the description or combinations thereof. The terms do not exclude the presence of one or more other characteristics, numbers, steps, operations, elements, parts or combinations thereof, or possibility of adding the same. In addition, it should be understood that, when a part, such as a layer, a film, a region or a plate, is said to be “on” another part, the part may be located “directly on” the other part, or other parts may be interposed between the two parts. Similarly, it should be understood that, when a part, such as a layer, a film, a region or a plate, is said to be “under” another part, the part may be located “directly under” the other part, or other parts may be interposed between the two parts.

All numbers, values and/or expressions representing amounts of components, reaction conditions, polymer compositions, and blends used in the description are approximations in which various uncertainties in measurement generated when these values are obtained from essentially different things are reflected. Thus, it should be understood that the values and/or the expressions may be modified by the term “about”, unless stated otherwise. In addition, it should be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

When a component, device, element, or the like of the present disclosure is described as having a purpose or performing an operation, function, or the like, the component, device, or element should be considered herein as being “configured to” meet that purpose or to perform that operation or function.

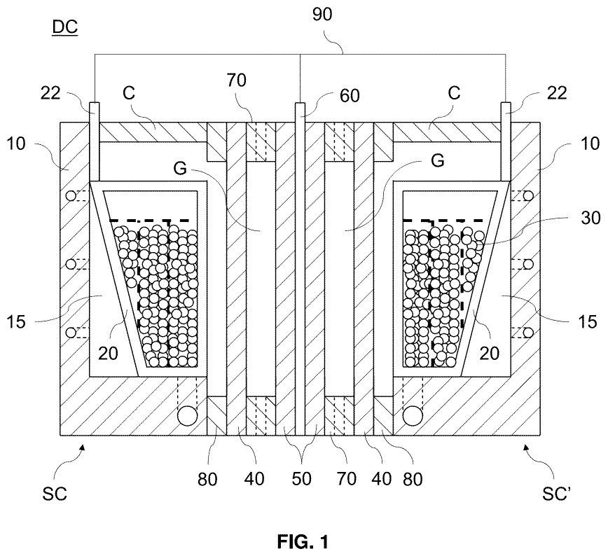

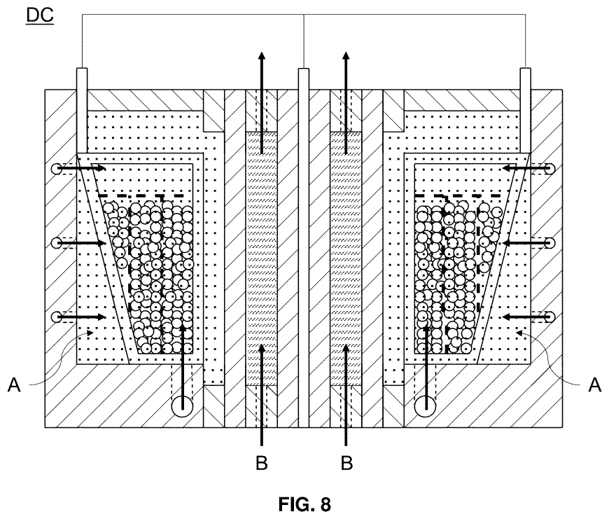

FIG. 1 shows a metal aqueous battery according to the present disclosure. For convenience of explanation and understanding, an anode electrolyte A and a cathode electrolyte B are not shown in FIG. 1. The anode electrolyte A and the cathode electrolyte B are shown in FIG. 8.

The metal aqueous battery may include a double cell DC obtained by stacking a pair of single cells SC. Each single cells SC includes an anode 30, a cathode 50, and a separator 40 located between the anode 30 and the cathode 50. A cathode current collector 60 is interposed between the respective cathodes 50 of the single cells SC so that the cathodes 50 face each other.

The cathode current collector 60 may be formed of an electrically conductive material. For example, the cathode current collector 60 may be a thin plate formed of stainless steel, which is plated with gold (Au).

The single cell SC may include a plate 10, an anode current collector 20 seated in an internal space 15 of the plate 10, the anode 30 accommodated in the anode current collector 20, the separator 40 stacked on the plate 10, the anode electrolyte A accommodated in the internal space 15 of the plate 10, the cathode 50 located on the separator 40, a cathode spacer 70 located between the separator 40 and the cathode 50 so as to form a gap G between the separator 40 and the cathode 50, and the cathode electrolyte B accommodated in the gap G.

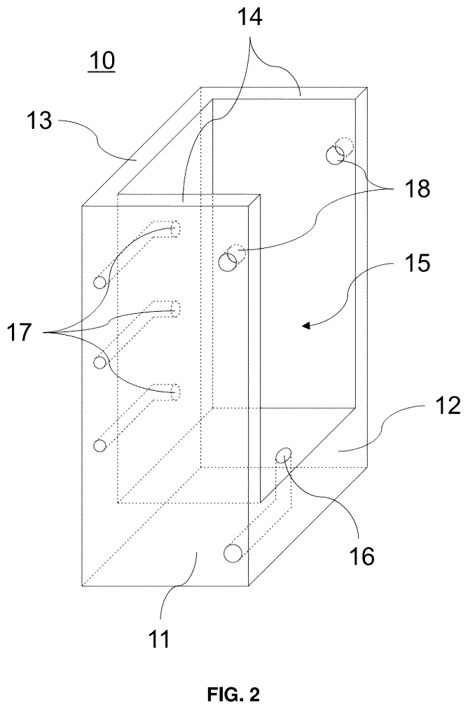

FIG. 2 shows the plate 10 according to the present disclosure. The plate 10 may be provided in the form of a barrel including a lower surface 11, a front surface 12, which is at least partially open, a rear surface 13 facing the front surface 12, and side surfaces 14, which connect the front surface 12 and the rear surface 13. Here, the front surface 12 may refer to one surface of the plate 10 facing the separator 40, and the rear surface 13 may refer to another surface of the plate 10 facing in the opposite direction to the front surface 12.

The plate 10 may be formed of a material having no electrical conductivity and excellent physical properties. For example, the plate 10 may be formed of polycarbonate.

The plate 10 may include the internal space 15 formed by opening at least a part of the front surface 12. In other words, a part of the front surface 12 is open and thus the internal space 15 is open to the outside.

In another embodiment, the upper part of the plate 10 is open, and thus the plate 10 may communicate with the outside. As illustrated in FIG. 1, the anode 30 may be supplied to the internal space 15 through the open upper part of the plate 10. Further, the metal aqueous battery may further include a cover C detachably installed on the open upper part of the plate 10. The size of the cover C is not particularly limited as long as it is capable of blocking the internal space 15 from the outside. Meanwhile, the cover C may be formed of a material that is not reactive with the anode electrolyte A and the anode 30.

The plate 10 may include a first anode electrolyte inlet 16 formed in one area of the lower surface 11, second anode electrolyte inlets 17 formed in some areas of the rear surface 13, and anode electrolyte outlets 18 formed in upper parts of the side surfaces 14. The anode electrolyte A may be introduced into the internal space 15 through the first anode electrolyte inlet 16 and the second anode electrolyte inlets 17 and may be discharged to the outside through the anode electrolyte outlets 18. This is described below.

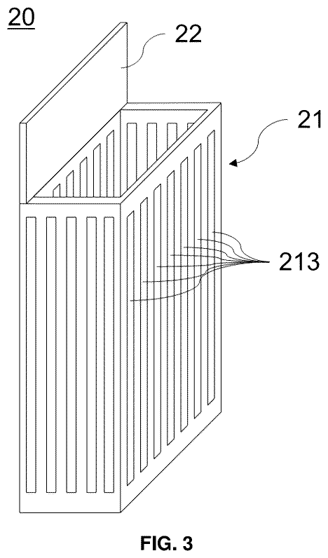

FIG. 3 shows an anode current collector 20 according to a first embodiment of the present disclosure. The anode current collector 20 may include a body 21 having a shape of a container, which has an open upper part and a closed lower part, so as to accommodate the anode 30. The anode current collector 20 may also include an extension 22 having a shape of a panel extending upwards from the body 21.

The anode current collector 20 may include a metal having electrical conductivity. Further, the anode current collector 20 may include a material having rigidity sufficient to withstand the weight of the anode 30. For example, the anode current collector 20 may include a stainless steel mesh.

The extension 22 may be exposed to the outside of the plate 10 and may be connected to the cathode current collector 60 by a conductive wire 90.

The body 21 may be provided in the form of a square barrel having an open upper part. Because the anode 30 and the body 21 contact each other through four sides, a contact area therebetween is wide Thus, the ionization area of the anode 30 may be increased, and the current density of the battery may be increased.

The body 21 may include a plurality of through holes 213 formed therethrough and having a predetermined shape. The anode electrolyte A may flow into and out of the body 21 via the through holes 213. Although FIGS. 3-7 show the through holes 213 formed in the shape of extending in the length direction of the body 21, the through holes 213 are not limited thereto and may have any shape as long as the anode electrolyte A may pass through the through holes 213 smoothly.

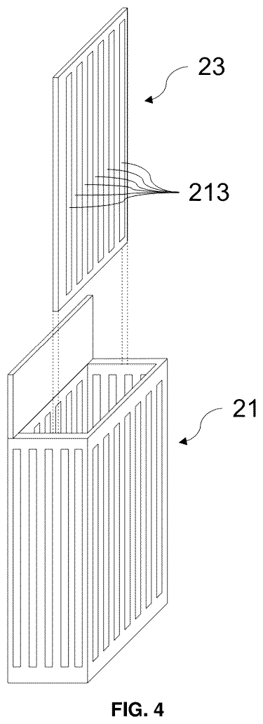

The anode current collector 20 may further include at least one auxiliary plate 23 inserted into the body 21, as shown in FIG. 4. The auxiliary plate 23 may include a plurality of through holes 213 formed therethrough and having a predetermined shape. When generating current and hydrogen in the metal aqueous battery, ionization of the anode 30 occurs on the contact surface between the anode 30 and the anode current collector 20. A non-contact surface between the anode 30 and the anode current collector 20 serves as a dead zone, the surface of the anode 30 is oxidized on the non-contact surface, and residues are produced. When the auxiliary plate 23 is inserted into the body 21, formation of the dead zone may be prevented. Thus, production of residues may be reduced, and cell performance may be increased.

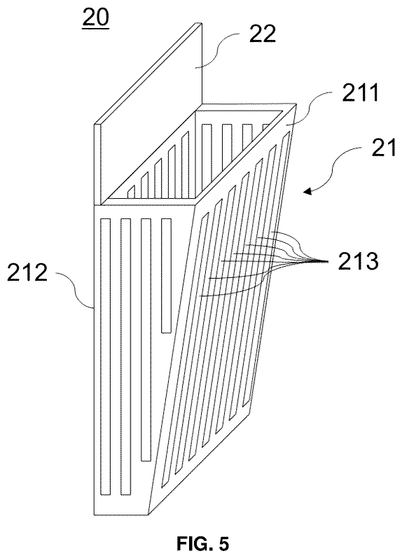

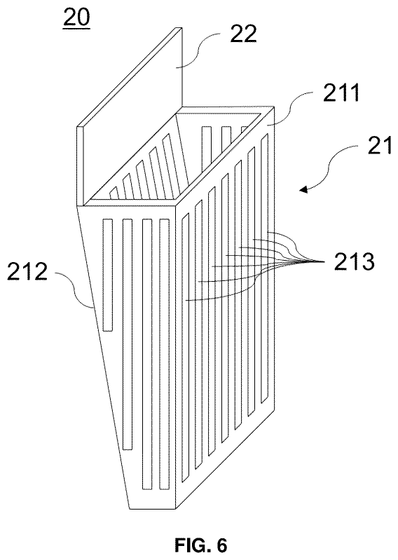

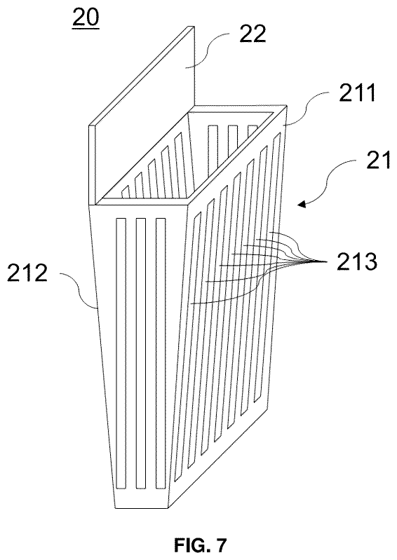

FIG. 5 shows an anode current collector 20 according to a second embodiment of the present disclosure. FIG. 6 shows an anode current collector 20 according to a third embodiment of the present disclosure. FIG. 7 shows an anode current collector 20 according to a fourth embodiment of the present disclosure. Referring to these figures, the anode current collector 20 may include a first plate portion 211 located close to the separator 40 and may include a second plate portion 212 facing the first plate 211. At least one of the first plate portion 211 or the second plate portion 212 may have an inclined shape from top to bottom. FIG. 5 shows that the first plate portion 211 is provided in the inclined shape, FIG. 6 shows that the second plate portion 212 is provided in the inclined shape, and FIG. 7 shows that the first plate portion 211 and the second plate portion 212 are provided in the inclined shape.

There may be differences in the resistance of the anode electrolyte A among the respective types based on a distance between the first plate portion 211 and the separator 40. An appropriate type of anode current collector 20 may be selected based on the specifications of the metal aqueous battery, etc. Further, because a space where the anode 30 is accommodated is inclined to become narrower toward the bottom, when the anode 30 is ionized and the size thereof decreases, the anode 30 piles up from the bottom. Thus, the contact area between the anode 30 and the anode current collector 20 is increased, and thus ionization of the anode 30 may occur more easily.

FIG. 8 shows flows of the electrolytes in the metal aqueous battery according to the present disclosure. The anode electrolyte A flows into the plate 10 from the lower surface and the side surfaces of the plate 10 and is discharged from the upper of the plate 10. Because the anode current collector 20 is in the form of a container, the anode electrolyte A may be supplied as above so that the anode electrolyte A may flow into the anode current collector 20 through all surfaces thereof. The cathode electrolyte B may flow into the metal aqueous battery from the lower part thereof and may be discharged to the outside from the upper part of the metal aqueous battery.

The anode 30 may include any material that may be ionized in the anode electrolyte A to generate electrons, for example, at least one selected from the group consisting of lithium (Li), sodium (Na), magnesium (Mg), zinc (Zn), aluminum (Al), and combinations thereof. In one embodiment, the anode 30 may include at least one selected from the group consisting of magnesium (Mg), zinc (Zn), aluminum (Al), and combinations thereof. Magnesium (Mg), zinc (Zn), and aluminum (Al) are stable in water and may thus be desirable in aqueous systems. In another embodiment, the anode 30 may include at least one selected from the group consisting of zinc (Zn), aluminum (Al), and a combination thereof. Zinc (Zn) and aluminum (Al) may be more desirable considering world reserves and price.

The anode 30 may have the form of pellets, such as spherical, ovoid, or cylindrical pellets. When the anode 30 is provided as ovoid pellets, the size of the anode 30 is the length of the major axis of the pellets. When the anode 30 is provided as cylindrical pellets, the size of the anode 30 is the diameter of the bottom surfaces of the pellets. The diameter of the anode 30 may be 1 mm to 10 mm. When the diameter of the anode 30 is less than 1 mm, the size of the anode 30 is reduced due to ionization, and thus the anode 30 may pass through the through holes 213. When the diameter of the anode 30 exceeds 10 mm, the specific surface area of the anode 30 is reduced, and thus performance of the metal aqueous battery may be deteriorated.

The metal aqueous battery may further include a separator spacer 80. The separator spacer 80 is interposed between the plate 10 and the separator 40, has a designated thickness, and is provided in the form of a frame with a hole in the central portion thereof.

The separator spacer 80 may support the edge of the separator 40 to expand the internal space 15 of the plate 10 by the thickness of the separator spacer 80. The thickness of the separator spacer 80 is not particularly limited and may be 5 mm to 20 mm.

The separator 40 may include a material having cation conductivity. For example, the separator 40 may include a perfluorinated sulfonic acid-based resin, such as Nafion. Therefore, the separator 40 may allow migration of cations between the anode 30 and the cathode 50 but may block movement of the anode electrolyte A and the cathode electrolyte B between the anode 30 and the cathode 50.

The separator 40 may include a material having anion conductivity. For example, the separator 40 may include at least one selected from the group consisting of poly(terphenylene), 1,4-diazabicyclo [2,2,2]octane-poly(ether sulfone), poly(aryl piperidinium), poly(phenylene oxide)-block-poly(vinyl benzyl trimethyl ammonium), and combinations thereof. Therefore, the separator 40 may allow migration of anions between the anode 30 and the cathode 50 but may block movement of the anode electrolyte A and the cathode electrolyte B between the anode 30 and the cathode 50.

The thickness of the separator 40 is not particularly limited and may be, for example, 25 μm to 250 μm.

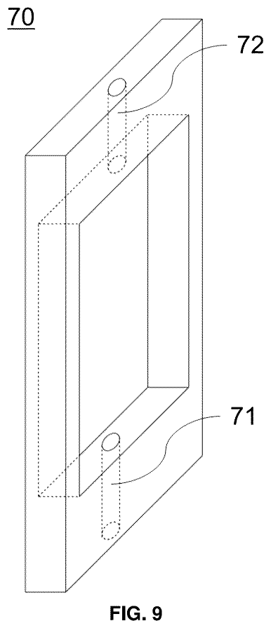

FIG. 9 shows the cathode spacer 70 according to the present disclosure. The cathode spacer 70 may be interposed between the separator 40 and the cathode 50. The cathode spacer 70 may be provided in the form of a frame with a hole in the central portion thereof and may support the edge of the separator 40 to form the gap G between the separator 40 and the cathode 50. The thickness of the cathode spacer 70 may be 5 mm to 20 mm.

The cathode spacer 70 may include a material, which does not react with the cathode electrolyte B and has chemical resistance. For example, the cathode spacer 70 may include polycarbonate.

The cathode spacer 70 may include a cathode electrolyte inlet 71 formed through a portion of one side surface of the cathode spacer 70 so as to communicate with the gap G. The cathode spacer 70 may also include a cathode electrolyte outlet 72 formed through a portion of another side surface of the cathode spacer 70 at a position spaced apart from the cathode electrolyte inlet 71 by a designated distance so as to communicate with the gap G. For example, based on FIG. 9, the cathode electrolyte inlet 71 may exist in the lower side surface of the cathode spacer 70, and the cathode electrolyte output 72 may exist in the upper side surface of the cathode spacer 70. Further, the cathode spacer 70 may include a plurality of cathode electrolyte inlets 71 and a plurality of cathode electrolyte outlets 72.

The cathode 50 may include a noble metal catalyst supported on a carrier. The carrier is not limited to a specific kind and may include, for example, at least one selected from the group consisting of carbon paper, carbon fiber, carbon felt, carbon black, carbon cloth, metal foam, a metal thin film, and combinations thereof. The noble metal catalyst is not limited to a specific kind and may include, for example, platinum (Pt).

The anode catalyst A may include an alkali metal hydroxide. In one embodiment, the anode catalyst A may include at least one selected from the group consisting of potassium hydroxide (KOH), sodium hydroxide (NaOH), and a combination thereof.

The concentration of the anode electrolyte A may be 3 M to 6 M. When the concentration of the anode electrolyte A is 6 M, a saturated solution of potassium ions (K⁺) or sodium ions (Na⁺) is created, and when the concentration of the anode electrolyte A is less than 3 M, ionization of the metal may not be sufficient, and therefore the concentration of the anode electrolyte A may be appropriately 3 M to 6 M.

The temperature of the anode electrolyte A may be 40° C. to 80° C. When the temperature of the anode electrolyte A is lower than 40° C., it may be difficult to obtain an effect of preventing passivation of the anode 30.

The cathode electrolyte B may include hydrogen ions and bicarbonate ions. In one embodiment, the cathode electrolyte B may include at least one selected from the group consisting of potassium hydrogen carbonate (KHCO₃), sodium hydrogen carbonate (NaHCO₃), and a combination thereof.

The concentration of the cathode electrolyte B may be 0.5 M to 3 M. When the concentration of the cathode electrolyte B is less than 0.5 M, the concentration of the cathode electrolyte B may affect the reaction rate due to a pH increase, and a saturated solution of potassium ions (K⁺) or sodium ions (Na+) is created at the concentration of the cathode electrolyte of 3 M Therefore, the corresponding range may be appropriate.

The temperature of the cathode electrolyte B may be 40° C. to 80° C. When the temperature of the cathode electrolyte B is within the above range, resistance in the metal aqueous battery may be lowered, and occurrence of overvoltage may be prevented.

Hereinafter, the operating process of the metal aqueous battery according to the present disclosure is described.

The anode electrolyte A flows into the internal space 15 of the plate 10 through the first anode electrolyte inlet 16 and the second anode electrolyte inlets 17.

When the anode 30 comes into contact with the anode electrolyte A, the anode 30 is ionized, and thus electrons are generated. The electrons migrate to the cathode current collector 60 along the anode current collector 20 and the conductive wire 90 and are then transmitted to the cathode 50.

Alkali metal ions, e.g., potassium ions (K+) or sodium ions (Na+), generated during the ionization process of the anode 30 move to the cathode 50 through the separator 40.

The cathode electrolyte B and carbon dioxide are supplied to the cathode 50 though the cathode electrolyte inlet 71. At the cathode 50, chemical elution reaction of carbon dioxide occurs as follows.

CO₂(g)+H₂O(I)→H⁺(aq)+HCO₃(aq)

Thereafter, at the cathode 50, hydrogen generation reaction occurs as follows.

2H⁺(aq)+2e⁻→H₂(g)

In addition, at the cathode 50, carbon dioxide is stored in the form of a salt as follows.

HCO₃(aq)+K⁺(aq)→KHCO₃(g)

HCO₃(aq)+Na⁺(aq)→NaHCO₃(g)

H₂ and KHCO₃ (or NaHCO₃) together with the cathode electrolyte B are discharged to the outside of the battery through the cathode electrolyte outlet 72.

Hereinafter, other embodiments of the present disclosure are described in more detail through the following Examples and Comparative Example. The following Examples and Comparative Example serve merely to exemplarily describe the present disclosure and are not intended to limit the scope and spirit of the present disclosure.

### Example 1

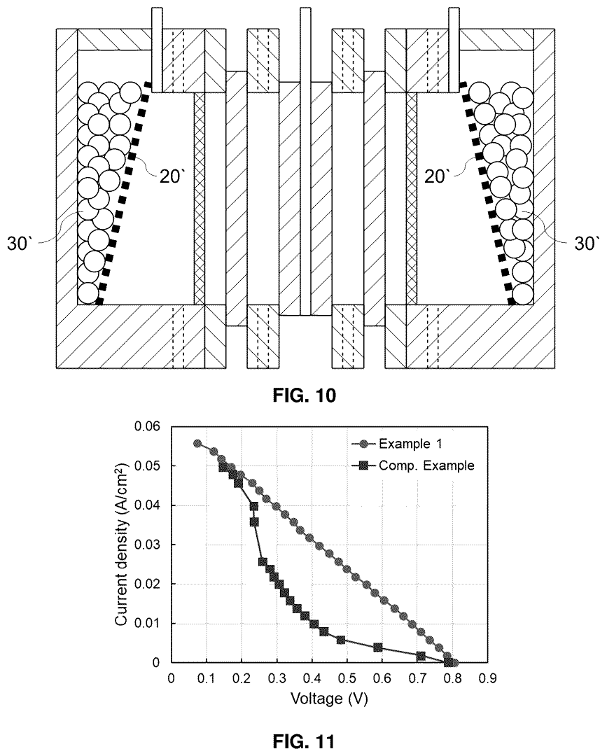

Cell performance of the double cell DC, as shown in FIG. 1, was evaluated by operating the double cell DC. Further, a double cell DC using flat plate-shaped anode current collectors 20′ rather than the container-shaped current collectors 20 used in the present disclosure was implemented, as shown in FIG. 10, and was set as Comparative Example. Zinc pellets with an average diameter 2 mm to 4 mm were used as the anode 30, and 6 M potassium hydroxide (KOH) was used as the anode electrolyte. Performance evaluation results of the respective double cells DC are shown in FIG. 11. Referring to this, it may be seen that the metal aqueous battery according to the present disclosure shows more stably high performance.

### Examples 2 to 4

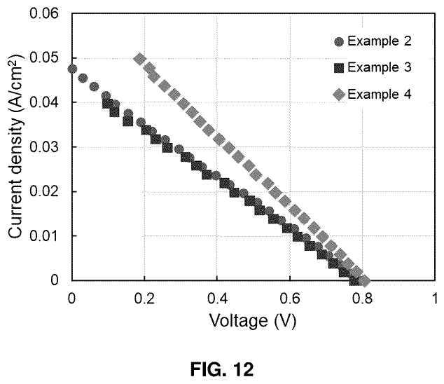

In Example 2, a metal aqueous battery using the square barrel-shaped anode current collectors shown in FIG. 3 was manufactured. In Example 3, a metal aqueous battery using the inclined anode current collectors shown in FIG. 5 was manufactured. In Example 4, a metal aqueous battery using the inclined anode current collectors shown in FIG. 6 was manufactured. Cell performances of the metal aqueous batteries according to Examples 2 to 4 were evaluated. Performance evaluation results of the respective metal aqueous batteries are shown in FIG. 12. Referring to this, it may be seen that the metal aqueous batteries according to Examples 2 to 4 are stably operated, and particularly the metal aqueous battery according to Example 4 shows the highest cell performance due to smooth flow of the anode electrolyte.

As is apparent from the above description, according to the present disclosure, a metal aqueous battery having improved current generation amount and current generation rate may be obtained.

According to the present disclosure, a metal aqueous battery in which an electrolyte may circulate smoothly may be obtained.

The effects of the present disclosure are not limited to the above-mentioned effects. The effects of the present disclosure should be understood to include all effects that may be inferred from the above description.

The present disclosure has been described in detail with reference to embodiments thereof. However, it should be appreciated by those having ordinary skill in the art that changes may be made in these embodiments without departing from the principles and spirit of the present disclosure, the scope of which is defined in the appended claims and their equivalents.

What is claimed is:

1. A metal aqueous battery, comprising a double cell comprising a pair of single cells, each single cell comprising:
an anode;
a cathode;
a separator interposed between the anode and the cathode;
a plate comprising an internal space configured to accommodate the anode, wherein the internal space of the plate communicates with an outside via an opening formed in one surface of the plate; and
an anode current collector seated in the internal space, wherein the anode current collector comprises a body having a shape of a container having an open upper part and a closed bottom surface so as to accommodate the anode,
wherein the pair of single cells are stacked so that the cathodes face each other, and
wherein a cathode current collector is interposed between the pair of single cells.

2. The metal aqueous battery of claim 1, wherein:
the plate is provided in a form of a barrel comprising a lower surface, a front surface configured to be at least partially open, a rear surface configured to face the front surface, and side surfaces configured to connect the front surface and the rear surface, and
the plate comprises a first anode electrolyte inlet formed in one area of the lower surface, a second anode electrolyte inlet formed in some areas of the rear surface, and anode electrolyte outlets formed in upper parts of the side surfaces.

3. The metal aqueous battery of claim 1, wherein:
the anode current collector further comprises an extension having a shape of a panel configured to extend upwards from the body, and
the extension is exposed to an outside of the plate and is connected to the cathode current collector by a conductive wire.

4. The metal aqueous battery of claim 1, wherein the body is in a form of a square barrel having the open upper part.

5. The metal aqueous battery of claim 1, wherein the body comprises:
a first plate portion provided close to the separator; and
a second plate portion configured to face the first plate portion,
wherein at least one of the first plate portion or the second plate portion of the body has an inclined shape from top to bottom.

6. The metal aqueous battery of claim 1, wherein:
the body comprises a plurality of through holes formed therethrough and having a predetermined shape, and
an anode electrolyte passes through the body via the plurality of through holes.

7. The metal aqueous battery of claim 1, wherein:
the anode current collector further comprises at least one auxiliary plate inserted into the body, and
the auxiliary plate comprises a plurality of through holes formed therethrough and having a predetermined shape.

8. The metal aqueous battery of claim 1, wherein the anode has a form of pellets.

9. The metal aqueous battery of claim 1, wherein an average diameter of the anode is 1 mm to 10 mm.

10. The metal aqueous battery of claim 1, wherein the anode comprises at least one selected from the group consisting of lithium (Li), sodium (Na), magnesium (Mg), zinc (Zn), aluminum (Al), and combinations thereof.

11. The metal aqueous battery of claim 1, wherein the cathode comprises a noble metal catalyst supported on a carrier.

12. The metal aqueous battery of claim 1, wherein each single cell further comprises a cathode spacer interposed between the separator and the cathode to form a gap between the separator and the cathode.

13. The metal aqueous battery of claim 12, wherein:
the cathode spacer is provided in a form of a frame with a hole in a central portion of the frame and supports an edge of the separator to form the gap, and
the cathode spacer comprises:
a cathode electrolyte inlet formed through a portion of one side surface of the cathode spacer so as to communicate with the gap; and
a cathode electrolyte outlet formed through a portion of another side surface of the cathode spacer at a position spaced apart from the cathode electrolyte inlet by a designated distance so as to communicate with the gap.

14. The metal aqueous battery of claim 1, further comprising a separator spacer interposed between the plate and the separator, the separator spacer having a designated thickness and provided in a form of a frame with a hole in a central portion of the frame,
wherein the separator spacer supports an edge of the separator to expand the internal space of the plate by a thickness of the separator spacer.

15. The metal aqueous battery of claim 1, further comprising:
an anode electrolyte accommodated in a space between the anode and the separator; and
a cathode electrolyte accommodated in a space between the cathode and the separator.

16. The metal aqueous battery of claim 15, wherein the anode electrolyte comprises an alkali metal hydroxide.

17. The metal aqueous battery of claim 15, wherein the cathode electrolyte comprises hydrogen ions and bicarbonate ions.
